(19) United States
(12) Patent Application Publication
(10) Pub. No.: US 2005/0063801 A1
(43) Pub. Date: Mar. 24, 2005

(54) Method and automated system for storing and distributing various objects or articles

(75) Inventors: Claude Durand, Gemenos, (FR); Emmanuel Dotte, Aix en Provence (FR); Robert Casanova, Marseille (FR); Jean-Luc Accardo, Marseille (FR)

Correspondence Address: HARRISON & EGBERT, 412 MAIN STREET, 7TH FLOOR, HOUSTON, TX, 77002, US

(73) Assignee: B Plus Development, Societe Anonyme

(21) Appl. No.: 10/500,749

(22) PCT Filed: Jan. 8, 2003
(86) PCT No.: PCT/FR03/00035

(30) Foreign Application Priority Data
Jan. 11, 2002 (FR) 02/00316

(51) Int. Cl. B65G 65/00

(52) U.S. Cl. 414/268

(57) ABSTRACT

A method for storing and distributing various articles, according to which the objects are stored on the trays of a rack structure. A suitable extraction system driven by a control and command system is movable in front of the rack structure in such a way that the extraction system is aligned in front of the bay of a tray carrying the stock of articles corresponding to the selected object so as to remove at least one of the articles. Objects or articles having the same reference are stored adjacent to each other on the upper side of one or several freely moving continuous conveyor belts, the conveyor belt(s) forming the receiving surface for one of the different bays of a storage tray. The conveyor belts are selectively motorized, causing the articles carried by the conveyor belts to be moved in the direction of a point of removal. The selective motorization is obtained by operating moving wheels mounted on a mobile extractor, which is movable in front of the storage rack and transports the conveyor belt(s) of the bay holding the selected or ordered articles by friction in such a way that at least the first one of the articles is transferred to a receiving surface of the extractor.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention presented here relates to an automated process and system for storing and distributing objects or articles having various sizes and shapes. The domain of the invention is that of warehouses for automatic dispensing and stocking systems that make it possible to select and remove various objects or articles automatically, such as, for example, food products, hardware products, hardware articles, parapharmaceuticals, multimedia, toys, etc.

### BACKGROUND OF THE INVENTION

Automatic dispensing machines are known from the prior-art (U.S. Pat. No. 3,126,124, U.S. Pat. No. 3,788,516, EP-0 779 605, BE-654 952) based on the solutions that enable the release of the article ordered and its fall by gravity into a delivery opening. These systems, based on the use of spirals, pushrods, rocker trays, cams, or other automatic mechanisms, have several disadvantages:
they are limited to the dispensing of articles that are not very fragile, having a shape and dimensions that are well defined;
the number of stock references does not exceed a few dozen; and
the simultaneous delivery of several articles is not possible.

Also, automated stocking systems (WO-88/03 506, WO-88/05 292) are known of the transstocker type. These systems generally require the use of intermediate containers (trays, tubs, drawers, cassettes, pallets, . . . ) of a specific size in or on which the objects are stocked. In the contrary case, these systems can only handle a few different sizes of objects.

Automatic stocking and removal systems (EP-0.779.605 A2, EP-0 991 037) are known, based on the stocking of objects in inclined or vertical racks and the removal of the article at the bottom of the stack. These systems are reserved for light objects that are non-deformable and not very fragile. The objects must actually support the weight of a stack of identical objects and a fall into a tub or onto a conveyor belt.

Also, robotized warehouses (EP-0.885.817 A1, FR-2.385.620, FR-2 378 697) are known based on the principle of stocking articles in rows equipped with pushrods activated by a transport device make it possible to transport the article ordered towards a delivery opening. Systems of this type also have several disadvantages:
they only deliver one article at a time, which leads to a sizeable delivery time when there are orders for several articles and affects their profitability;
the reloading of the stock makes it necessary to stop the warehouse and produces a net loss of use; and
the principle of extraction, based on the force of a row of articles implemented in these systems, is not adapted to certain sizes of objects such as flexible bags or blister bags, which require an additional mechanism in order to be processed.

Finally, automated stocking devices (EP-0.026.754 A1, EP-1 004 996) are known in which the objects are stocked on trays equipped with conveyor belts. The use of individual and independent control instruments for the motorization of the belts during the removal of objects leads to an increased cost and a low modularity of the stocking zone. In addition, the objects must withstand a fall into a tub or onto a conveyor belt.

The problems posed thus notably consist of: obtaining an automatic stocking and dispensing system for objects while at the same time processing a large number of articles of a varied nature, shapes, and sizes; enabling the delivery of several of these objects simultaneously, enabling the reloading of the stock of objects, while functioning as a storehouse; simplifying the construction, the functioning, and the maintenance of the installations, and in making it possible to create these latter conditions with easily adaptable configurations and obstructions depending on the restrictions of the installation.

### BRIEF SUMMARY OF THE INVENTION

The process of the invention applies to an automatic stocking and dispensing system of the type consisting of an assembly of racks comprising a plurality of shelves or trays for stocking articles, a mechanism for receiving and transport driven by a command and control system able to move in front of this assembly of racks, and to position itself in front of the tray supporting the stock of articles that corresponds to the selected object, in order to receive at least one of these articles extracted from the stock by delivery, and a user interface comprising mechanisms for display and selection of the type of objects selected by the user during his order, possibly equipped with mechanisms for automatic payment of the price of the objects ordered in the case of a use of the system for commercial purposes.

According to a first characteristic arrangement of the process and the system of the invention, the objects or articles having a same reference are stocked one after the other, on the upper side of one or more endless idle-mounted conveyor belts, this conveyor belt or belts comprising the receiving surface of one of the different bays of a stocking rack, and the selective motorization of this conveyor belt or belts, driving the displacement of the articles that they support in the direction of a removal point, is obtained by the application of motorized rollers mounted on a mobile extractor moving in front of the stocking rack, and driving by friction the conveyor belt(s) of the bay supporting the selected or ordered articles, in a manner so as to enable the transfer of the first of these articles onto a receiving surface of the extractor.

This process produces several advantages:
it makes it possible to stock and dispense fragile or deformable articles;
the reloading of the stock of objects can be done without interrupting the functioning of the system, which prevents operating losses during operations for reconstituting the reserves;
the starting of the movement of the conveyor belts on which the objects are stocked is ensured by the extractor(s), which limits the cost and the complexity of the stocking trays; and
the number of stocking racks and their arrangement in one or two rows can be easily modulated as a function of the number and the volume of objects to be dispensed and the configuration of the place in which the system is installed.

According to another characteristic arrangement of the process and the system of the invention, the receiving surface of each stocking tray is comprised of a plurality of slightly spaced endless narrow conveyor belts idle-mounted individually, and the metallic framework arranged under the upper side of these belts is provided with rows of openings extending in parallel to the belts and below the spaces arranged between them for the removable mounting of vertical separators that enable the division of each tray into several bays with equal or different widths and having receiving surfaces that are comprised of one or more conveyor belts.

According to another characteristic arrangement of the process and the system of the invention, the vertical members and the lateral edges of the metallic structure of the trays are constructed in a complementary manner in order to enable removable attachment at different heights of the trays onto the vertical members.

Using these characteristic arrangements, the configuration of the rows can be easily adapted to the width and the height of the articles to be dispensed and this configuration can be easily modified if necessary in moving the separations and/or the trays. The number of stocking racks and their arrangement on one or more rows can be modulated depending on the number and the volume of the objects to be dispensed and the configuration of the place in which the system is installed.

According to another characteristic arrangement of the process and the system according to the invention, the extractor deposits the objects taken, during an order for several articles, onto a collecting mat with which it forms a mobile assembly capable of moving in front of the racks.

The temporary stocking of objects after their removal according to this advantageous arrangement makes it possible, during an order for several objects, to deliver all of the objects simultaneously after having successively extracted them. Thus, the global duration of the dispensing operation is reduced, and the system is rapidly available for a new order.

In addition, the transfer of objects from their stocking site to the delivery opening is done by transport on the horizontal conveyor mat, which enables the processing of objects of various types, shapes, and sizes, prevents the drops of objects and limits the mechanical stresses to which the objects are subject.

### BRIEF DESCRIPTION OF THE SEVERAL VIEWS OF THE DRAWINGS

The above goals, characteristics, and advantages, and still others, are best described in the description that follows and the attached drawings:

FIG. 1 is a schematic perspective view showing a possible embodiment form of the invention.

FIG. 2 is a schematic view of a rack comprised of several stocking trays of objects according to the invention.

FIG. 3 shows the detail of a stocking tray according to the invention.

FIG. 4 shows a detail of the rear of a rack according to the invention.

FIGS. 5 and 6 show, seen from above, two possible arrangement forms of the system according to the invention, highlighting the modularity of the stocking zone of the objects.

FIG. 7 shows a mat that ensures the temporary stocking of the objects removed connected to two extractors according to the invention.

FIGS. 8 to 12 show, schematically, the functioning of the extractor in different phases of removal of an object.

Reference is made to the drawings mentioned to describe the advantageous example, though in no way restrictive, for implementing the process and realization of the system according to the invention.

### DETAILED DESCRIPTION OF THE INVENTION

In the presentation that follows, it is specified that:
the word “reference” designates a category of identical objects
the word “article” designates an example of objects having a certain reference
the word “rack” designates an assembly comprised of a plurality of stacked trays supported by a carrying structure, for example, comprised of vertical members;
the word “tray” designates the assembly of constituent elements of each shelf of the racks; each tray can receive several references of articles;
the term “bay” designates each division of a tray assigned to receive several articles of a same reference; and
the word “row” designates an assembly of racks arranged in alignment.

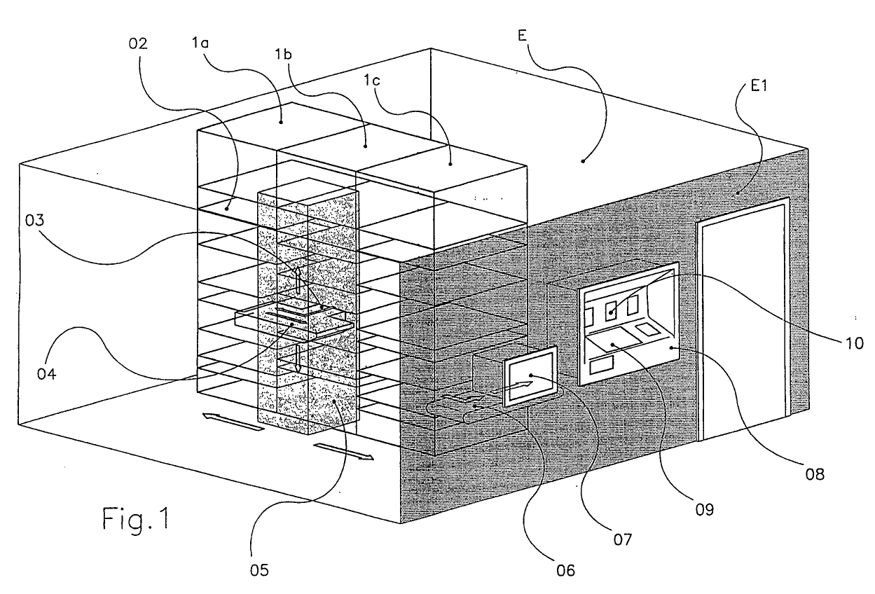

FIG. 1 shows a perspective view of a possible embodiment form of the invention in which the stocking zone is comprised of three racks assigned to a single row. In this drawing, the main constituent elements of the system of the invention are shown schematically, i.e. the racks 1a, 1b, 1c, comprised of the stocking trays 2, the extractor 3 of the objects and the collecting mat 4 that enables the temporary stocking of the objects extracted before their delivery, the robot 5 which ensures the displacement of the assembly (extractor 3+collecting mat 4), the delivery mat 6 that transports the objects towards the delivery opening 7, and the user interface 8 equipped with a screen for display and data capture 9 and peripherals for automatic payment 10.This system is possibly contained in an enclosure E in the FRONT wall E1 of which the delivery opening 7 and the user interface 8 are arranged.

The functioning of a system of this type is easily designed.

The user forms and validates his order using the screen for display and data capture 9, which is equipped with a touch-sensitive plate. He selects his objects by navigating in a virtual catalog in which the objects in stock are classed by families. Additional information (photos, characteristics, price . . . ) can be displayed during the selection of an object. When the user has validated his order, the system successively reduces the stocks of each of the objects ordered then delivers the entire order in the zone of the delivery opening 7.

In the case of a use of the system for the paid dispensing of objects, reducing the stocks of the objects is initiated after the validation of the payment, and a receipt that repeats the detail and the price of the delivered objects is delivered to the client. Several payment modes can be used (coins, bills, electronic coin purse, bank card or store card).

The user can also place an order remotely from a distance, in connecting over a computer network, for example, of the internet or intranet type, linked to the system and capable of querying the stock. A file number is allotted to the user and the objects that he ordered are reserved for him for a specified time period. In order to get his order, the user calls, on the screen for display and data capture 9, the file number that was allotted to him remotely, then makes the payment of the ordered objects, which initiates the removal of the reserved objects and their delivery into the delivery chamber 7.

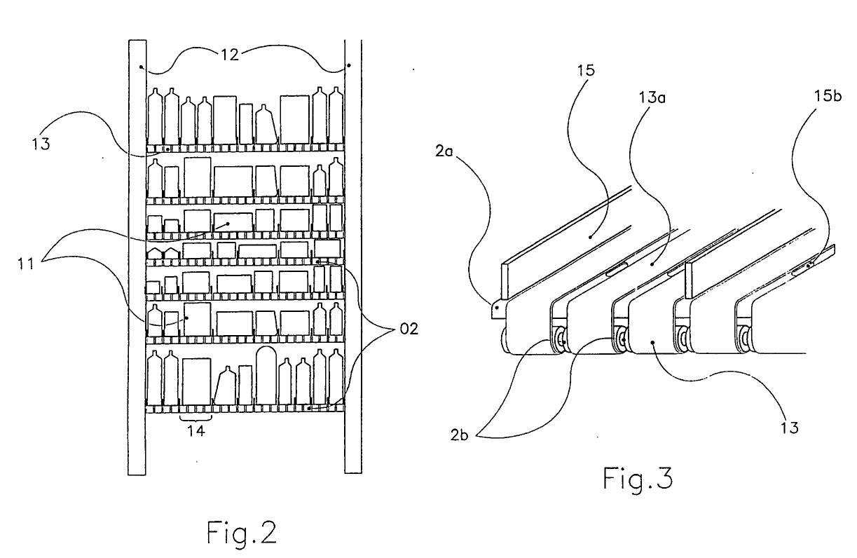

FIG. 2 shows, in a front view, a rack 1 comprising seven trays 2 supported, for example, by four vertical members 12. The vertical members 12 and the lateral sides of the rigid framework 2a of the trays 2 are arranged in a complementary manner to allow a removable attachment, and at different heights, of the trays on the vertical members. For example, the vertical members 1 are equipped with slightly spaced superposed openings, while the lateral sides of the rigid framework 2a of the trays 2 are equipped with lugs designed to engage into the openings. The height of the trays 2 is thus adjustable, as well as the number of trays 2 by row 1, which can be selected as a function of the height of the objects 11.

As FIG. 3 shows, each tray 2 is comprised of a plurality of endless conveyor belts 13 individually idle-mounted on the pulleys 2b installed at the ends in front of and behind the rigid framework 2a of the trays 2. The upper horizontal or approximately horizontal side 13a of these endless belts 13 comprises the surface on which the stocked objects 11 rest. The conveyor belts 13 have a reduced identical width (for example, on the order of 35 mm) and are slightly offset (for example, on the order of 13 mm). Each tray arranged in this way has, for example, a width on the order of 120 cm and a depth on the order of 80 cm.

The rigid framework 2a of the trays 2 arranged between the upper and lower sides of the endless belts 13 is provided with openings 15b aligned in parallel to the conveyor belts 13 and accessible between the spaces separating the upper sides 13a of them. Each row also consists of partitions or separations 15 made in order to be able to be positioned vertically between the stocking and conveyor belts 13. The lower edge of these separations is, for example, equipped with lugs (not shown) or similar assembly elements designed to engage in the openings 15b of the rigid framework 2a. The trays 2 are of a type divided into several bays 14 opened at the front and at the rear, a bay functioning for the stocking of a plurality of objects having a same reference. A bay 14 comprises one or more conveyor belt(s) 13 depending on the width of the object 11 which is stocked there. It is understood that the width of the bays can be rapidly and easily modified depending on the needs, by simple lateral displacement of the removable separations 15.

The objects processed by the process and the system of the invention can be of a varied nature: grocery products, parapharmacy products, detached automobile parts, toys, multimedia products, etc. These objects can be of any shape, i.e. deformable, but must, however, have a stable support surface. Spherical or cylindrical objects fitted on a generatrix are excluded, except for being placed on adequate supports or disposable bases.

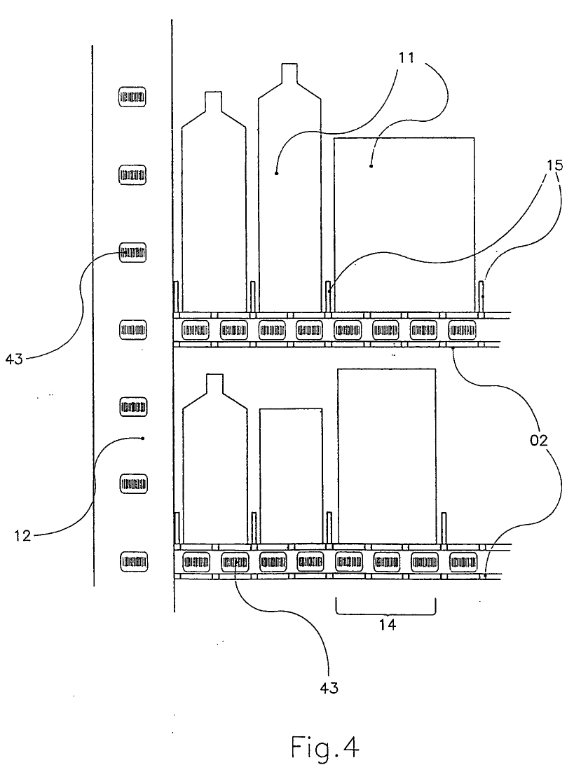

Several racks 1 can be attached together in order to form an adjustable stocking magazine, according to one or two rows, or even more than two rows. The layout of the racks and bays 14 is registered in the command and control system by the intermediary of a reading terminal that has portable bar codes. As shown in FIG. 4, the bar codes 43 mark for this purpose each of the belts 13 of the trays 2 as well as the positioning heights possible for a tray 2 on a vertical member 12. These bar codes 43 are placed behind the racks, on the opposite side of that of the removal. Thus, during the operations for reloading the stock and modification of the layout of the magazine, the updating of the data of the command and control system is done instantly by the operator with the help of this terminal.

The sizeable depth of the trays 2 associated with the principle of reloading the bays from the rear of the rack enables the reloading of the magazine without it being necessary to interrupt the function of the system and the possible removal of articles in the process.

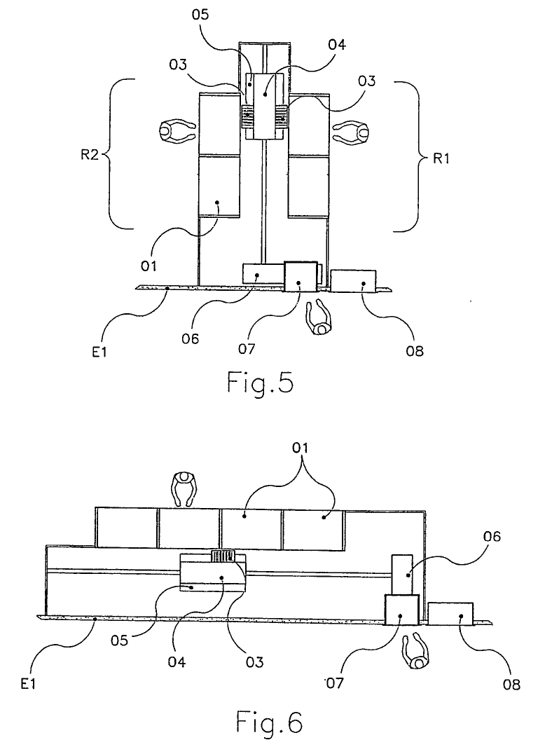

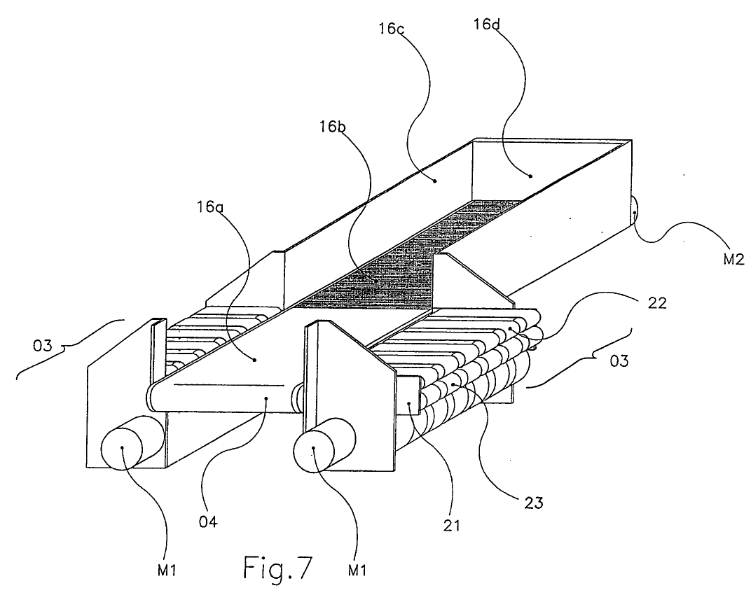

FIGS. 5 and 6 show, for the purpose of example, two possible configurations of the magazine. The rows or the two rows of racks can be parallel (FIG. 6) or perpendicular (FIG. 5) to the wall E1 in which the delivery opening 7 and the user interface 8 are mounted, which permits an adaptation of the system to the geometry of the place where they are intended to be installed. In the case of a magazine having two parallel stocking rows R1 and R2, two symmetrical extractors 3 are mounted on both sides of the collecting mat 4, as shown notably in FIG. 7.

The installation also consists of a mobile assembly moving in front of the bays 14 of the row or rows of rack 1, this assembly comprising one or two extractors 3 and a collecting mat 4, the extractor or each extractor being arranged laterally relative to the collecting mat 4.

The extractor or each extractor 3 is comprised of a plurality of endless conveyor belts 22 whose upper side 22a comprises a mobile receiving surface and whose width and spacing corresponds approximately to the width and the spacing of the conveyor belts 13, while the collecting mat 4 is comprised of a single endless conveyor belt.

The conveyor belts 22 and the conveyor belts 4 run in perpendicular directions and the surfaces of their active upper side are, preferably, placed at the same level, or approximately at the same level.

The collecting mat 4 comprises a receiving zone 16a on which the extractor or extractors 3 off-loads (NT) and a collecting zone 16b bordered laterally by the fixed walls 16c and at its front end by a wall 16d.

The starting of movement of the conveyor belts 22 and 4 is ensured by the motors M1 and M2, respectively, preferably comprised of electric motors.

The assembly (extractor 3+collecting mat 4) is loaded on a robot having two axes 5 moving in front of the rack wall 1 and ensuring the positioning of an extractor 3 facing the bay corresponding to the object to be taken out of stock. The extractor or each extractor 3 is equipped with a mobile slide valve 21 having a width and a spacing corresponding approximately to the width and the spacing of the belts 13 of the trays 2. The width of the slide valve 21 is equivalent to that of the largest object stocked which corresponds, for example, to the distance comprised between the exterior edges of a group of six belts 13.

On the collecting mat 4, the collecting zone 16 permits the temporary stocking of the objects after their extraction.

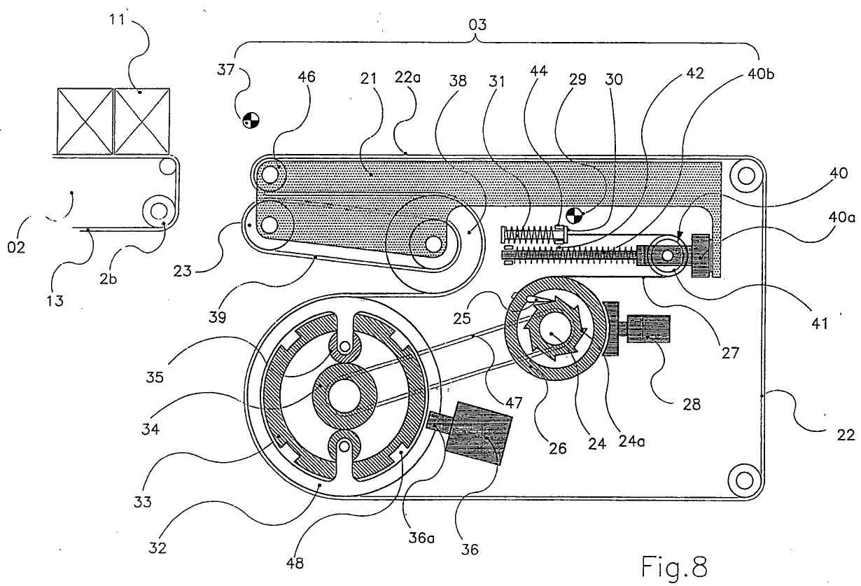

The motorization allowing the movements for docking of an extractor and the driving of the belts 13 involved by docking is shown in FIGS. 8 to 12.

At the level of each of the two lateral sides of the slide valve 21 of an extractor 3, the motor shaft 24 drives a crown 26 using a clutch having a catch mechanism comprised of a ratchet 25 carried by the crown and supported on a toothed wheel 24a set on the motor shaft 24. On the crown 26, one of the ends of a cable 27 is affixed, the other end of which is affixed on one of the ends of a shaft 30 mounted having a translational axial capacity in a fixed guide 44, against the opposing action of a helicoidal spring 31 arranged around the shaft and supported by the intermediary of its ends opposed, on the one hand, against the fixed guide and, on the other hand, against a shoulder comprising the other end of the shaft. These two springs 31 ensure an elastic support of the pressing rollers 23 on the front ends of the endless conveyors 13 of the trays 2. On the other hand, the cable 27 is wound on a pulley 41 supported by the mobile instrument of a magnetic valve designated in its entirety by the reference 40 in FIG. 8. This mobile instrument is united with a shaft 40b mounted with an axial latitude of movement in a fixed guide 45 against the opposing action of a helicoidal spring 42 arranged around the shaft 40b.

A brake 28 is mounted near the crown 26 in a manner such that its brake shoe or block 28a can be supported on the crown, in an active position.

The mobile slide valve 21 carries the pressure rollers 23 designed to come to support against the front ends of the belts 13, the wheels 38 for driving the pressure rollers in rotation by the intermediary of the crowns 39, and the front pulleys 46 on which the conveyor belts 22 are wound whose upper side 22a rotates above the slide valve. The front pulleys 46 are arranged slightly set back relative to the pressure rollers 23, in a manner such that during the docking of the slide valve 21, only the pressure rollers maintain contact with the belts 13.

A first fixed sensor 29 makes it possible to detect the position of the shaft 30, while a second sensor 37, united with the slide valve 21, ensures the detection of the rear side of the object 11a during removal.

The extractor comprises clutch systems that enable the selective control of the drive of each conveyor belt 22 and pressure roller 23 associated with it. Each of these clutch systems comprises a drum 32 on which a conveyor belt 22 is wound, this drum being driven in rotation by the intermediary of an epicycloidal gear train whose planetary pinion gear 34 is driven by a crown 47 wound on a pulley supported on the motor shaft 24. This epicycloidal gear train comprises the motor pinion 34, satellites 35, an intermediate crown 33 and the drum 32 on which the conveyor belt 22 is wound. The intermediate crown 33 is equipped with peripheral notches 48 in which the mobile sliding bolt 36a of an electric latch 36 can engage. Due to this arrangement, only the belt(s) 22 located facing the bay 14 to be taken out of stock is or are set into movement when an article 11 is removed.

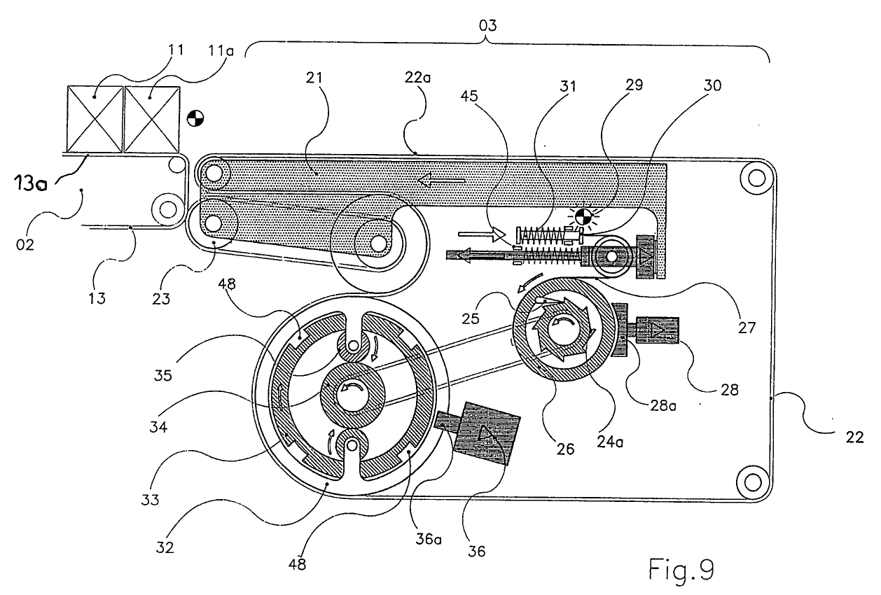

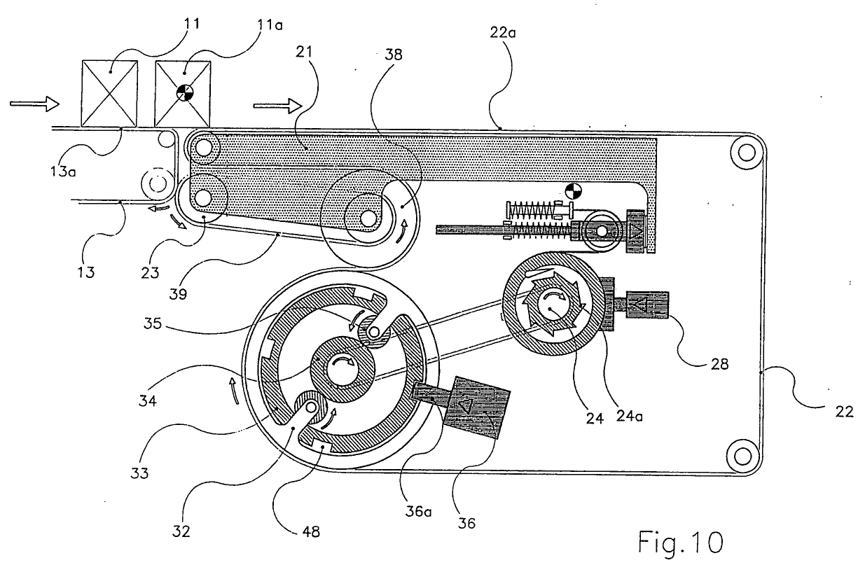

When the latch 36 is not driven (FIG. 9), the rotation of the motor pinion 34 is transmitted to the intermediate crown 33 by the intermediary of satellites, and the drum 32 remains fixed. When the latch 36 is driven (FIG. 10), it immobilizes the intermediate crown 33. The rotation of the pinion 34 is thus transmitted to the drum 32 by the intermediary of the satellites 35. In its rotation, the drum 32 sets into motion the belt 22 by adhesion.

In an advantageous manner, the linear speed and the adhesion of the belts 22 of the extractor are greater than those of the belts 13 of the plates 2. This difference in speed is linked to the different winding radii of the belts 22 on the wheels 38, the crowns 39 on these same wheels 38 and on the rollers 23 as well as the diameter of the rollers 23 that drives the belts 13 by friction.

In the following, the function of this extractor is described during the different phases of removal of the objects. For a better readability, a single belt 22 of the slide valve 21 is shown.

At rest, the extractor is in the configuration shown in FIG. 8. For the removal of an object, a senestrorsum rotation of the motor shaft 24 drives, by the intermediary of the system of the free wheel 25, a rotation of very limited amplitude of the crown 26 and the displacement of the cable 27, which generates the output of the slide valve 21 in the direction of the stocking plate 2 (FIG. 9). The pressure rollers 23, linked to the slide valve 21, then come into contact with the belts 13 of the tray 2. The docking of the slide valve 21 against the tray 2 causes the traction of the cable 27, the axial displacement of the shaft 30 and the crushing of the spring 31 which calibrates the force of pressure of the pressure rollers 23 on the belts 13. This crushing moves the target 30, comprised of the end of the shaft linked to the cable 27 and whose detection by the sensor 29 simultaneously causes the motor shaft to stop and the tightening of the brake 28 on the crown 26, ensuring in this way that the slide valve is maintained in position against the tray 2.

During the docking of the mobile slide valve, the upper side 22a of the belts 22 are placed at the same level as that of the upper side 13a of the belts 13 against which the pressure rollers 23 are placed in support.

The docking of the slide valve having been completed, the motor shaft 24 is set in rotation dextrorsum and the belts 22 opposite the bay to be taken out of stock are clutched due to the immobilization of the intermediate crown 33 of their clutch system, resulting from the engagement of the bolt 36a of the latch 36 in one of the notches 48 of the crown (FIG. 10). An activator (not shown) selectively activates the latch 36 of the clutch system of one or more belts 22, as a function of the number of conveyor belts 13 comprising the bay supporting the object to be removed. In their movement, the belts 22 drive in rotation the pressure rollers 23 by the intermediary of the wheels 38 and crowns 39. The pressure rollers 23 drive by friction the belts 13 of the bay to be taken out of stock. In their movement, the belts 13 move the stocked objects 11 with them. When the first object 11 a of the bay is transferred to the extractor, it is then accelerated by the belts 22, whose linear velocity and adhesion are greater than that of the belts 13. Thus, one obtains the shelling of the objects during their removal.

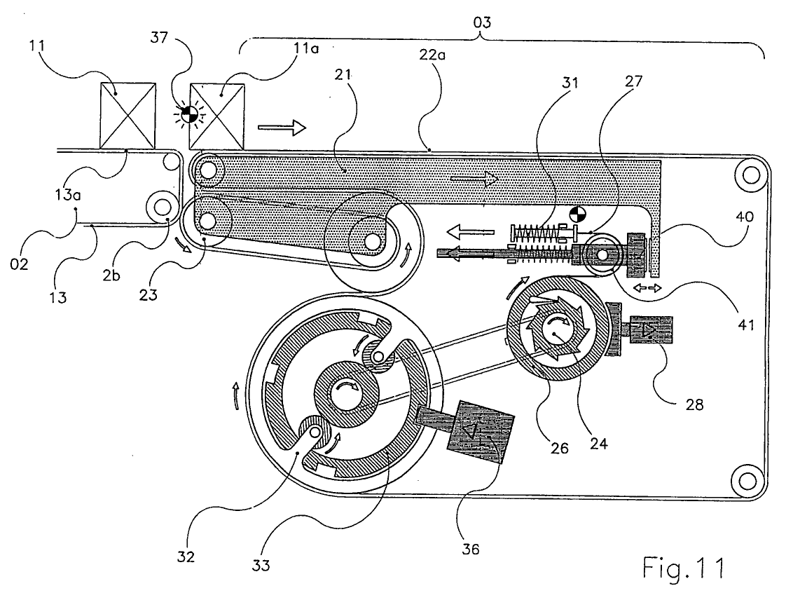

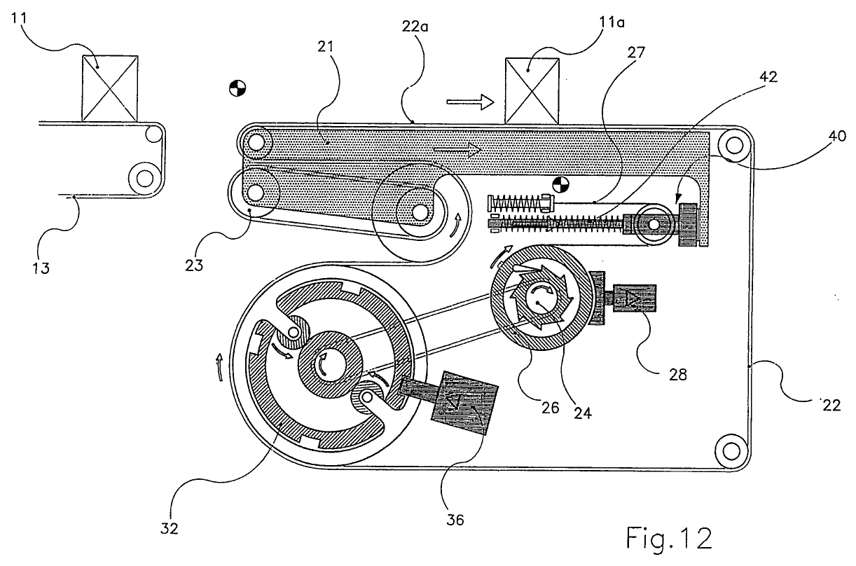

In detecting the passage of the rear side of the object 11a during removal, the sensor 37 controls the separation of the magnetic valve 40 and the relaxation of the brake (FIG. 11). Thus, the slide valve 21 is disconnected from the winding axle of the cable 41 for a fraction of a second, which permits its immediate detachment from the tray 2 by the relaxation of the tension of the spring 31. The loss of contact between the rollers 23 and the belts 13 stops the advance of the other objects 11 of the bay. In order to end the retraction of the slide valve 21, the relaxation of the brake 28 has freed the crown 26 and the total return of the slide valve is ensured by the spring 42 (FIG. 12). During this phase, the belts 22 continue their movement and ensure by conveyance the transfer of the removed object to the receiving zone 16a of the collecting mat 4, which transports it into the collecting zone 16b.

If the order consists of other objects, the extractor 3 comes to be positioned facing the bay corresponding to the next object and performs a new removal from stock there. The objects previously extracted are then stocked temporarily in the collecting zone 16b of the collecting mat 4. The slippery surface of the conveyor belt of the mat 4 allows it to slide under the objects collected when they arrive against the stop 16d. When all the objects ordered have been extracted, the collecting mat 4 is activated in the opposite direction and comes alongside the delivery mat 6 in order to transfer the objects there, which are then transported towards the delivery opening 7 by the delivery mat 6. The dimensions of each of the products in stock are known by the command and control system such that a voluminous order can be divided up and delivered several times.

The fact that the transfer of the objects ordered 11 from their stocking bay 14 to the delivery opening 7 is ensured by conveyance on their supporting side, at least the conveyor belts 13, 22, 4 and 6, is also a characteristic arrangement of the present invention. This conveyance over a succession of horizontal or approximately horizontal conveyor mats notably enables the processing of objects of varied types, shapes and/or sizes, prevents objects from dropping and limits the mechanical stresses to which the objects are subjected.

1. Process for selective storing and distributing of various objects or articles, according to which the objects are stocked in bays of trays of an assembly of racks in front of which moves, on two perpendicular axes, a system for proper extraction controlled by a command and control system, in a manner so as to position itself in front of the bay of a tray holding the stock of articles corresponding to the selected object, in order to remove at least one of these articles, said process comprising the steps of:
storing the objects or articles of a same reference one after the other, on an upper side of one or more endless idle-mounted conveyor belts, one or more of the conveyor belts comprising a receiving surface for each of the different bays of a stocking rack; and
driving, in selective motorization of the conveyor belts, the displacement of the articles that they support in the direction of a removal point by application of motorized rollers mounted on a mobile extractor moving in front of the stocking rack, and driving by friction the conveyor belt(s) of the bay supporting the selected or ordered articles, in a manner so as to enable the transfer of the first of these articles onto a receiving surface of the extractor.

2. Automated system for storing and distributing various objects and articles comprising:
an assembly of a plurality racks comprising a plurality of superposed trays, each rack comprised of one or more bays for stocking articles, so that the objects of a same reference can be placed in a same bay;
a means for receiving and transport driven by a command and control system able to move in front of said assembly of racks, on two perpendicular axes, in a manner so as to be positionable in front of the bay supporting the stock of articles that corresponds to the selected object and to transfer this article to an opening or delivery chamber;
an extraction system enabling the transfer of the selected object onto the receiving and transport mechanism; and
a user interface comprising means for display and selection of the objects, and if necessary, mechanisms for automatic payment;
wherein a receiving surface of the bays on which the stocked articles rest is comprised of the upper side of endless idle-mounted conveyor belts, and wherein receiving and transport means of the extraction system is comprised of an extractor comprised of motorized friction rollers, means for application of the motorized friction rollers against the conveyor belt or group of conveyor belts of the bay supporting the selected or ordered articles, in a manner so as to allow the transfer of the first of these articles onto the receiving surface of the extractor.

3. Process according to claim 1, wherein the objects removed in sequence from one or more bays by the extractor during an order for several articles are transferred by the extractor onto a collecting mat moving with the extractor and able to receive and temporarily store the removed objects before they are transferred to an opening or delivery chamber.

4. Process according to claim 1, wherein transfer of objects from their stocking bay to the delivery opening is ensured by conveyance on their support side using the conveyor belts.

5. Process according to claim 1, further comprising: regulating of the width of the bays as a function of the size and the conformation of the objects by movable partitions dividing each tray into several bays comprising a variable number of conveyor belts.

6. Process according to claim 1, further comprising: assigning bar codes to each of the conveyor belts of the trays, and to each possible positioning height of the trays on the vertical members; wherein layout of the trays and the bays is registered in the command and control system of the system using a portable bar code reading terminal.

7. Process according to claim 1, further comprising:
selecting the objects remotely over a computer network linked to the system;
reserving the ordered objects remotely, for a specified time period; and
removing and delivering the objects ordered by the system, after the user calls the file number remotely displayed using the display and data capture screen, and, if necessary, payment of the price of the objects using the automatic payment peripherals.

8. System according to claim 2, wherein said receiving surface of each stocking tray is comprised of a plurality of slightly spaced endless narrow conveyor belts, idle-mounted individually; wherein a metallic framework arranged under the upper side of these belts is provided with rows of openings extending in parallel to the belts and below the spaces arranged between them for the removable mounting of vertical separators that enable the division of each tray into several bays with equal or different widths and having receiving surfaces that are comprised of one or more conveyor belts.

9. System according to claim 8, wherein vertical members and the lateral edges of the metallic structure of the trays are constructed in a complementary manner in order to enable the removable fixation at different heights of the trays onto the vertical members.

10. System according to claim 2, wherein the receiving surface of the extractor or each extractor is comprised of the upper side of a plurality of endless conveyor belts having the width and spacing corresponding approximately to the width and spacing of the conveyor belts of the trays.

11. System according to claim 2, further comprising: an assembly for extraction comprising at least one extractor and a collecting mat comprised of an endless conveyor belt.

12. System according to claim 10, wherein the upper side of the conveyor belts of the extractor or each extractor and the upper side of the collecting mat, rotate in perpendicular directions and are preferably placed at the same level.

13. System according to claim 2, wherein the assemblies of racks are arranged in two parallel rows facing each other and wherein the extraction assembly can move between the two rows and are comprised of a collecting mat and two extractors arranged on both sides of the collecting mat.

14. System according to claim 2, wherein the extractor or the assembly comprised of the extractor and the collecting mat is carried on a robot with two axes moving in front of the rows of the racks.

15. System according to claim 2, wherein the assembly of mechanisms ensuring the transfer of the ordered objects from their stocking bay to the delivery opening is comprised of conveyor belts.

16. System according to claim 2, wherein each of the belts of the trays, as well as the possible positioning heights of the trays on the vertical members are identified using bar codes placed behind the racks on the opposite side from the removal side.

17. System according to claim 8, wherein the conveyor belts of the extractor or each extractor are driven at a speed greater than that of the conveyor belts of the trays and wherein the carrying surface of the conveyor belts of the extractor or each extractor have, preferably, a coefficient of adhesion greater than the carrying surface of the conveyor belt of the trays.

18. System according to claim 2, wherein the extractor or each extractor is comprised of a sensor that detects the space created behind the object removed and starts the uncoupling of the friction rollers and the belts of the trays and thus stops the advance of the other objects of the bay involved.

19. System according to claim 2, wherein the extractor or each extractor comprises:
a mobile slide valve carrying the pressure rollers designed to come to rest against the front ends of the belts of the trays, wheels for driving in rotation the pressure rollers using the crowns and the front pulleys on which are wound the conveyor belts of the extractor, the upper side of which rotates above this slide valve; and
means for ensuring movements for docking and detachment of the mobile slide valve, in a manner so that the slide valve can occupy two positions, either a first neutral position in which the pressure rollers are far from the ends of the belts of the trays and a second active position according to which the rollers are pressed against the ends of the belts of the trays.

20. System according to claim 1, wherein the extractor or each extractor is comprised of means ensuring elastic support of the pressure rollers against the front ends of the belts of the trays.

21. System according to claim 19, wherein means for ensuring the docking and detachment movements of the mobile slide valve comprise a motor shaft driving unidirectionally, by the intermediary of a catch, a crown, a brake mounted near the crown and the shoe or block of which can be supported on the periphery of the crown, a flexible connection such as a cable affixed, by the intermediary of its opposite ends, on the one hand, to the crown and, on the other hand, to the end of the shaft axially mobile against the opposing action of a spring, this cable winding on a pulley carried by a mobile instrument of a magnetic valve that makes it possible to make the pulley united in translation with the mobile slide valve.

22. System according to claim 21, characterized in that the mobile instrument (40a) of the magnetic valve (40) is subjected to the action of a return spring (42) tending to restore the position of adherence to the mobile slide valve (21).

23. System according to claim 10, wherein the driving in rotation of the pressure rollers is obtained by the conveyor belts using a graduated wheel over a large diameter of which each belt wound and by a crown wound over the small diameter of the graduated wheel and over the pressure roller.

24. System according to claim 23, wherein the extractor or each extractor comprises systems for clutching making possible the selective drive of each conveyor belt, each of these clutch systems comprising a drum on which a conveyor belt is wound, this drum being driven in rotation by the intermediary of an epicycloidal gear train consisting of a motor pinion, satellites, an intermediate crown and the drum, the intermediate crown of this epicycloidal gear train provided with peripheral notches into which the mobile sliding bolt of an electric latch can engage.
